(19) United States
(12) Patent Application Publication
(10) Pub. No.: US 2025/0166443 A1
(43) Pub. Date: May 22, 2025

(54) CASH HANDLING APPARATUS

(71) Applicant: Glory Ltd., Himeji-shi (JP)

(72) Inventors: Satoru KOBAYASHI, Himeji-shi (JP); Yang CHEN, Himeji-shi (JP)

(73) Assignee: Glory Ltd., Himeji-shi (JP)

(21) Appl. No.: 18/945,847

(22) Filed: Nov. 13, 2024

(30) Foreign Application Priority Data
Nov. 17, 2023 (JP) 2023-196026

(51) Int. Cl. G07D 11/245

(52) U.S. Cl. CPC G07D 11/245; G07D 2201/00; G07D 2211/00

(57) ABSTRACT

A cash handling apparatus is configured to be used for cash handling by a predetermined store and another store different from the predetermined store. The cash handling apparatus includes: a cash handling unit configured to handle cash; and a control unit configured to control the cash handling unit to perform cash handling including a depositing process of storing, into the apparatus, cash received from outside the apparatus, and a dispensing process of discharging cash stored in the apparatus to outside the apparatus, such that the control unit determines whether a store that performs the cash handling is the predetermined store or the other store, and in a case where the store is the other store, the control unit restricts the dispensing process, based on a predetermined dispensing restriction.

### CROSS REFERENCE RELATED TO APPLICATION

The present application is a continuation of, and claims priority to, Japanese patent application JP 2023-196026 filed Nov. 17, 2023, the entire contents of which is incorporated herein by reference.

### TECHNICAL FIELD

The present disclosure relates to a cash handling apparatus that performs a depositing process and a dispensing process.

### BACKGROUND ART

Conventionally, various cash handling apparatuses capable of handling cash have been used. For example, Japanese Patent No. 5922055 discloses a depositing and dispensing apparatus that is used together with a POS (Point of Sales) terminal in a store. The depositing and dispensing apparatus performs a process of depositing proceeds from sales collected from the POS terminals and a process of dispensing a change fund which is cash for change to be used in each POS terminal. A management server manages inventory amount information indicating the kind and the quantity of cash in each of depositing and dispensing apparatuses and POS terminals. Based on the inventory amount information, the management server selects, from among the depositing and dispensing apparatuses, an apparatus into which proceeds from sales collected from a POS terminal can be deposited, and reserves a depositing process. The management server selects a depositing and dispensing apparatus into which proceeds from sales collected from a POS terminal can be deposited and from which a change fund to be used in the POS terminal can be dispensed, and reserves a depositing and dispensing process. The cash handling can be assuredly performed by making the reservation of a depositing and dispensing apparatus capable of performing cash handling for the POS terminal.

### SUMMARY

Cash handling apparatuses of the conventional technology is assumed to be used by a store in which the apparatus is installed. When the store having the cash handling apparatus installed therein allows another store to use the apparatus, and a plurality of stores use one cash handling apparatus, there may arise a problem. For example, when the other store dispenses cash from the cash handling apparatus and the cash in the apparatus runs short, the store with the installed apparatus will be unable to dispense cash. If dispensing of cash by the other store is restricted too much, convenience for the other store is impaired.

The present disclosure has been made in view of the problem, as well as other problems, of the conventional art, and the present disclosure addresses these issues, as discussed here, with a cash handling apparatus that can be used by a plurality of stores.

A cash handling apparatus according to one aspect of the present disclosure is used for handling cash by a predetermined store and another store different from the predetermined store. The cash handling apparatus includes: a cash handling unit configured to handle cash; and a control unit configured to control the cash handling unit to perform cash handling including a depositing process of storing, into the apparatus, cash received from outside the apparatus, and a dispensing process of discharging cash stored in the apparatus to outside the apparatus. The control unit determines which store, the predetermined store and the other store, performs the cash handling. When the store that performs the cash handling is the other store, the control unit restricts the dispensing process, based on a predetermined dispensing restriction.

The objects, features, advantages, and technical and industrial significance of this disclosure will be better understood by the following description and the accompanying drawings of the disclosure.

### BRIEF DESCRIPTION OF THE DRAWINGS

FIG. 1 is a schematic diagram for describing a cash handling apparatus according to the present embodiment;

FIG. 2 shows an example of a cash handling system including the cash handling apparatus;

FIGS. 3A and 3B each show a specific example of the cash handling apparatus;

FIGS. 4A to 4C each show an example of information to be used by the cash handling apparatus;

FIG. 5 is a diagram for describing an example in which a management store keeps cash in the cash handling apparatus;

FIGS. 6A to 6C each show a schematic diagram for describing an example of cash handling performed by the cash handling apparatus;

FIGS. 7A to 7D each show an example of a screen to be displayed on an operation/display unit when the cash handling apparatus performs cash handling;

FIGS. 8A to 8C each show an example of a screen to be displayed on the operation/display unit when the cash handling apparatus performs an unreserved dispensing process;

FIG. 9 is a diagram for describing another example of a menu screen for other stores different from the management store; and

FIG. 10 is a flowchart showing an example of a flow of processing performed by the cash handling apparatus.

### DESCRIPTION OF EMBODIMENTS

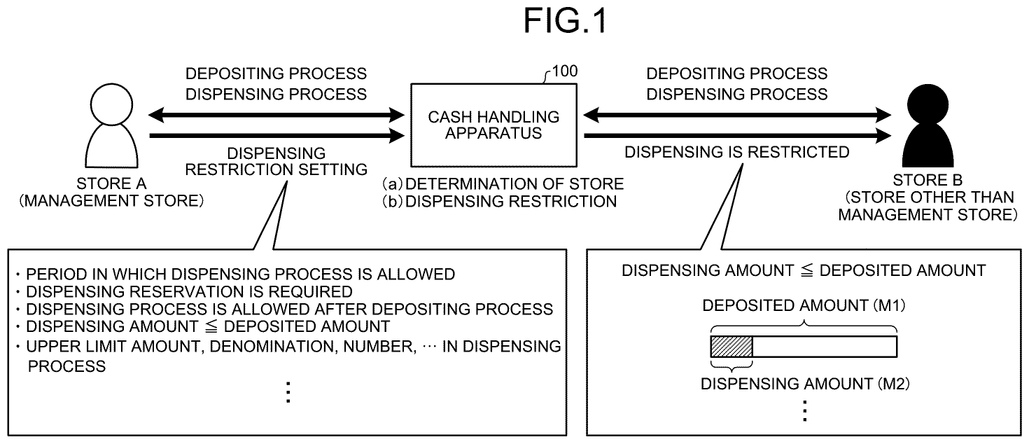

Hereinafter, a cash handling apparatus according to the present disclosure will be described with reference to the accompanying drawings. FIG. 1 is a schematic diagram for describing a cash handling apparatus 100 according to the present embodiment. The cash handling apparatus 100 is installed and used in a management store or a predetermined place managed by the management store. The cash handling apparatus 100 is used by the management store and one or a plurality of stores other than the management store. Hereinafter, the management store may be referred to as a store A, and a store other than the management store may be referred to as a store B or “other store”. Additionally, a clerk of the management store may be referred to simply as the store A or the management store, and a clerk of the other store may be referred to simply as the store B or the other store.

The store A (management store) is a store that manages cash stored in the cash handling apparatus 100. The store A manages both collecting cash from the cash handling apparatus 100 and replenishing cash into the cash handling apparatus 100. For example, when cash in the cash handling apparatus 100 needs to be collected by a cash-in-transit (CIT) company in order to transport the cash to a predetermined base, such as a financial institution or a cash center, the store A requests the CIT company to collect the cash. For another example, when the cash handling apparatus 100 needs to be replenished with cash, the store A requests the CIT company to perform the cash replenishment.

As shown in FIG. 1, the store A can perform a plurality of kinds of cash handling including a depositing process and a dispensing process, by using the cash handling apparatus 100. The depositing process is a process in which cash received from outside the apparatus is recognized and counted, and stored inside the apparatus. The dispensing process is a process in which the cash handling apparatus 100 accepts an input of a dispensing amount and discharges cash equivalent to the dispensing amount from inside the apparatus to outside the apparatus. During the dispensing process, instead of or in addition to the dispensing amount, denominations and the quantity for each denomination of cash to be dispensed may be designated.

Similar to the conventional apparatus, the cash handling apparatus 100 can accept an operation by the store A, to perform various kinds of cash handling including the depositing process and the dispensing process. The cash handling apparatus 100 can also accept a reservation for a dispensing process in which denominations and the quantity for each denomination of cash to be dispensed are designated in advance, to perform the reserved dispensing process.

Additionally, as shown in FIG. 1, the cash handling apparatus 100 has a feature of accepting a setting by which the store A restricts cash handling allowed to the other store, and restricts, based on the setting, cash handling that can be performed by the other store. The store A can set different restrictions for each of a plurality of other stores.

The store A can restrict a period in which the other store can use the cash handling apparatus 100. For example, the store A restricts use of the cash handling apparatus 100 by the other store to one or a plurality of time periods, such as one hour from 6 o'clock in the morning and two hours from 19 o'clock in the evening in one day. The store A can set a different time period, in which use of the cash handling apparatus 100 is allowed, for each store.

The store A can restrict a dispensing process such that the other store cannot perform the dispensing process unless the other store has previously performed a depositing process in the cash handling apparatus 100. The store A can restrict an amount of cash that can be dispensed by the other store through the dispensing process, to be equal to or less than the amount of cash deposited in the depositing process having been performed by the other store before the dispensing process. In a case where this restriction has been set, when the other store wants to dispense cash from the cash handling apparatus 100, the other store has to perform a depositing process before the dispensing process. The other store cannot perform the dispensing process unless the other store has previously deposited cash equal to or more than the dispensing amount to be dispensed in the dispensing process, into the cash handling apparatus 100. For example, when the other store needs to dispense cash for change, the other store can perform the dispensing process on condition that the other store has already deposited cash, of which amount is equal to or more than the amount of the cash for change, into the apparatus.

The store A can restrict the dispensing process to be performed by the other store, to a dispensing process based on a dispensing reservation reserved by designating denominations and the quantity for each denomination of cash to be dispensed. In a case where this restriction has been set, the other store that has made the dispensing reservation cannot perform a dispensing process for cash other than that in the denominations and the quantity for each denomination designated in the dispensing reservation, and other stores that have not made a dispensing reservation cannot perform a dispensing process.

The store A can restrict the upper limit amount of cash that can be dispensed by the other store from the cash handling apparatus 100. In a case where this restriction has been set, the other store cannot perform a dispensing process for cash exceeding the set upper limit amount. The store A can set different upper limit amounts for respective other stores.

The store A can restrict denominations and the quantity for each denomination of cash that can be dispensed by the other store from the cash handling apparatus 100. In a case where this restriction has been set, the cash handling apparatus 100 secures predetermined cash in the apparatus, and uses remaining cash excluding the secured cash, to perform a dispensing process. For example, the store A can perform setting such that cash in the denominations and the quantity for each denomination designated in a dispensing reservation is secured in the cash handling apparatus 100. In this case, cash that can be dispensed in dispensing processes by stores different from the store having made the dispensing reservation is restricted to the remaining cash excluding the cash secured for the dispensing reservation. The dispensing processes that are not reserved are performed by using cash separated from the cash kept for the reserved dispensing processes. For example, the store A can perform setting such that denominations and the quantity of cash designated for the store A is to be secured in the cash handling apparatus 100, and cash that can be dispensed by the other store is restricted to the remaining cash excluding the cash secured for the store A.

As shown in FIG. 1, the store B (other store) can perform cash handling including a depositing process and a dispensing process in the cash handling apparatus 100, but the content of the dispensing process is restricted based on the setting prepared by the store A in advance. For example, as shown in FIG. 1, the cash handling apparatus 100 determines whether the store that performs the depositing process is the store A or the store B (a). When the determination result is the store B, the cash handling apparatus restricts the content of the dispensing process that can be performed by the store B (b).

When the store A has set a restriction that the dispensing amount by the store B is equal to or less than the deposited amount by the store B, the store B cannot perform a dispensing process unless the store B has previously performed a depositing process in the cash handling apparatus 100. In the dispensing process to be performed after the depositing process, the dispensing amount by the store B is restricted to be equal to or less than the deposited amount of cash in the depositing process.

For example, the store B uses the cash handling apparatus 100 for a depositing process for proceeds from sales and a dispensing process for a change fund. The store B designates denominations and the quantity for each denomination of change necessary in business hours of the store B, and reserves a dispensing process for the change fund equivalent to a dispensing amount M2. After the business hours of the store B, the store B deposits cash collected from the store into the cash handling apparatus 100. The cash handling apparatus 100 performs a depositing process to confirm that a deposited amount M1 of cash deposited by the store B is equal to or more than the dispensing amount M2 according to the dispensing reservation. In a case where the deposited amount M1 is equal to or more than the dispensing amount M2 of the change fund, the cash handling apparatus 100 performs a dispensing process to dispense the change fund in the denominations and the quantity for each denomination designated in the dispensing reservation of the store B.

When the deposited amount M1 is less than the dispensing amount M2, an error occurs, and the cash handling apparatus 100 does not perform the dispensing process for the store B. The store B, which has dispensed the change fund from the cash handling apparatus 100, performs business while using the change fund for change in transactions with customers. After the business hours, the store B deposits, into the cash handling apparatus 100, the residual change fund and the proceeds from sales obtained through the transactions. The store B performs a depositing process in an amount obtained by adding the amount of proceeds from sales of the day to the amount of change fund dispensed on the previous day. Therefore, the deposited amount M1 typically does not become less than the dispensing amount M2, and the store B can obtain a change fund by performing a dispensing process after performing a depositing process.

When the other store has deposited the proceeds from sales of the day and the remainder of the change fund dispensed on the previous day, into the cash handling apparatus 100, and dispenses a change fund for the following day from the cash handling apparatus 100, only the proceeds from sales of the day are deposited into the cash handling apparatus 100. The cash handling apparatus 100 can perform a process for depositing proceeds from sales of each of other stores, into a bank account of each store.

The cash handling apparatus 100 transmits account information of the other store acquired in advance and the amount of proceeds from sales obtained by performing cash handling, to a predetermined server. The predetermined server performs account handling based on the account information and the amount of proceeds from sales. For example, proceeds from sales equivalent to an amount (M1-M2) obtained by subtracting the dispensed amount M2 from the deposited amount M1 shown in FIG. 1, is deposited into the bank account of the store B.

By merely collecting the cash in the store B after the business hours and depositing the cash into the cash handling apparatus 100, the store B can obtain a change fund necessary in business hours on the following day and deposit the proceeds from sales into the bank account. For example, after the store B merely performs one operation of starting cash handling for depositing cash into the cash handling apparatus 100, the change fund is automatically dispensed based on the dispensing reservation made by the store B and the proceeds from sales is automatically deposited into the bank account of the store B.

With reference to the content of the dispensing reservation made by the other store, the store A can specify in advance denominations and the quantity for each denomination of cash that will be dispensed by the other store from the cash handling apparatus 100. The store A can request a CIT company to perform replenishment of cash into the cash handling apparatus 100 based on the dispensing reservations. The cash handling apparatus 100 may automatically perform a process of requesting replenishment of cash by the CIT company, based on the content of the dispensing reservations. This avoids a situation where the cash in the denominations and the amount necessary for the store A runs short and the store A cannot dispense the cash from the cash handling apparatus 100. The store A may be able to delete the dispensing reservation of the other store or change the content of the dispensing reservation as necessary.

When cash for change runs short during business hours, the other store can perform an unreserved dispensing process by performing a depositing process for depositing cash into the cash handling apparatus 100. The other store designates denominations and the quantity for each denomination of cash to be dispensed within a range up to an upper limit that is the deposited amount in the depositing process having performed for the unreserved dispensing process. When the unreserved dispensing process is performed after the depositing process, if the deposited amount exceeds the dispensed amount, an amount obtained by subtracting the dispensed amount from the deposited amount is deposited into the bank account of the other store.

For example, when thirty 500-JPY coins are necessary for change during the business hours, the store B may deposit two 10,000-JPY notes, i.e., 20,000 JPY in total, to the cash handling apparatus 100, designate thirty 500-JPY coins for the dispensing process, and dispense these coins of which the total amount is 15,000 JPY. In this case, the cash handling apparatus 100 performs a process for the account handling, such that 5000 JPY obtained by subtracting the dispensing amount of 15,000 JPY from the deposited amount of 20,000 JPY is deposited into the bank account of the store B.

In a case where the store A prepares extra cash in the cash handling apparatus 100 in advance so as to be ready for unreserved dispensing processes, other stores can perform unreserved dispensing processes in the cash handling apparatus 100. The cash handling apparatus 100 accepts unreserved dispensing of cash within a range of denominations and the quantity for each denomination of cash that the store A has prepared for unreserved dispensing processes.

For example, when the store B that wants to dispense thirty 500-JPY coins has deposited 20,000 JPY, if cash for unreserved dispensing processes runs short and only twenty-five 500-JPY coins can be dispensed, information indicating this fact is displayed on a display unit of the cash handling apparatus 100. This allows the store B to change the coins to be dispensed to twenty-five 500-JPY coins and dispense these coins. In this case, 12,500 JPY out of the deposited amount of 20,000 JPY is dispensed from the cash handling apparatus 100, and the remaining 7500 JPY is deposited into the bank account of the store B.

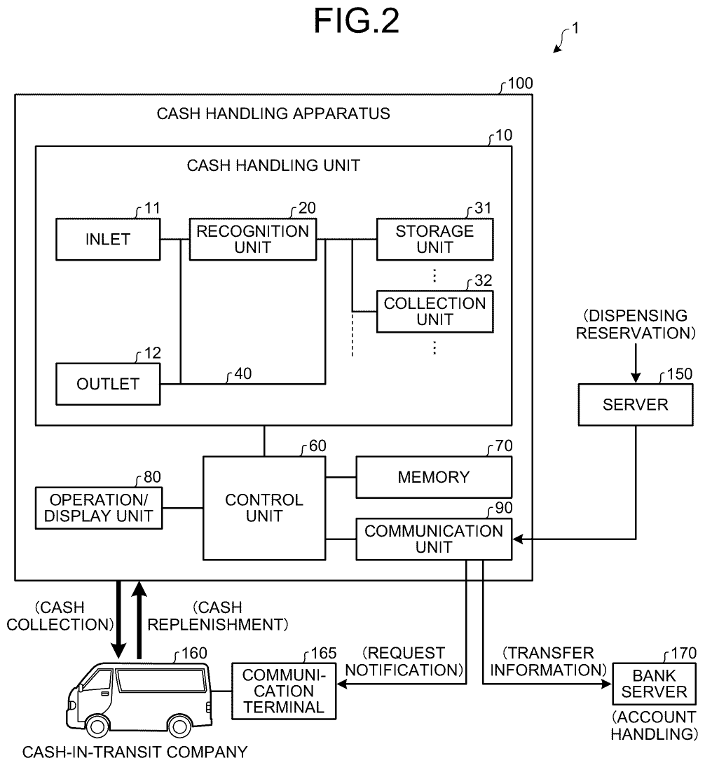

FIG. 2 shows an example of a cash handling system 1 including the cash handling apparatus 100. As shown in FIG. 2, the cash handling system 1 may include a server 150 used by the management store and the other stores, in addition to the cash handling apparatus 100. The cash handling system 1 may include a bank server 170 that performs account handling, and a communication terminal 165 used by a CIT company 160.

The cash handling apparatus 100 includes a cash handling unit 10, a control unit 60, a memory 70, an operation/display unit 80, and a communication unit 90. The control unit 60 controls the functions and operations of each component of the cash handling apparatus 100. The control unit 60 can control each component with reference to various kinds of information stored in the memory 70, based on an instruction performed by using the operation/display unit 80, information acquired from an external device via the communication unit 90, and the like. For example, a program corresponding to the control unit 60 is stored in advance in a dedicated storage device, and the control unit 60 operates by performing the program by using hardware such as a CPU. The functions and operations of the cash handling apparatus 100 described in the present embodiment may be realized through the control unit 60. The processes, performed by the cash handling apparatus 100, described in the present embodiment may be realized by the control unit 60. The control unit 60 may be implemented in one or a plurality of electric circuits or processing circuits, that is programmed so as to be able to perform processes, includes one or a plurality of general-purpose processors, application specific processors, integrated circuits, ASIC (Application Specific Integrated Circuits), CPUs (Central Processing Units), conventional-type circuits, and/or a combination of these.

The memory 70 is a non-volatile storage device for storing various kinds of information necessary for operations of the cash handling apparatus 100. The information stored in the memory 70 includes setting information regarding a dispensing restriction set for each of other stores by the store A, other-store information for managing other stores, inventory amount information capable of specifying cash in the cash handling apparatus 100, and account handling information necessary for account handling of proceeds from sales of other stores.

At least a part of the setting information, the other-store information, the inventory amount information, and the account handling information may be stored not in the memory 70 but in the server 150. The other store may perform a dispensing reservation by operating a terminal communicably connected to the server 150. In this case, the cash handling apparatus 100 may perform each process by acquiring necessary information from the server 150, by using the communication unit 90 as an acquisition unit.

The communication unit 90 is used for communicating with an external device. The communication with the external device is performed by using a dedicated line or a public line such as the Internet. In one example, the cash handling apparatus 100 specifies denominations and the quantity for each denomination of cash, with which the cash handling apparatus 100 needs to be replenished, based on the inventory amount information and a dispensing reservation. The cash handling apparatus 100 transmits a notification to the communication terminal 165 of the CIT company 160 via the communication unit 90, to request the replenishment, and the CIT company 160 replenishes the cash handling apparatus 100 with cash. In another example, if the cash handling apparatus 100 transmits account information and a deposited amount to the bank server 170 via the communication unit 90, the bank server 170 performs the account handling. When the proceeds from sales of the store B deposited into the cash handling apparatus 100 is to be used as cash owned by the store A, account handling of moving a fund equivalent to the proceeds from sales, from the bank account of the store A to the bank account of the store B, may be performed. When the proceeds from sales of the store B deposited into the cash handling apparatus 100 is to be used as cash owned by the CIT company, account handling of moving a fund equivalent to the proceeds from sales, from the bank account of the CIT company 160 to the bank account of the other store B, may be performed.

The operation/display unit 80 is used for inputting/outputting various kinds of information. For example, a touch panel-type liquid crystal display device is used as the operation/display unit 80. The operation/display unit 80 functions as an operation unit for inputting various kinds of information on cash handling. The operation/display unit 80 functions as a display unit for displaying various kinds of information on cash handling. The operation unit and the display unit may be provided separately. The operation/display unit 80 may be provided separately from the cash handling apparatus 100 and connected to the cash handling apparatus 100.

The cash handling apparatus 100 can specify a store that performs cash handling, by an authentication process, based on a store ID (identification information), a password, etc., that have been prepared for uniquely identifying each store and inputted through the operation/display unit 80. The method for the authentication process is not particularly limited. For example, the cash handling apparatus 100 may further include a reading device that reads a store ID from a bar code, a magnetic card, an IC card, or the like, and perform an authentication process, based on the store ID read by the reading device.

Through operation of the operation/display unit 80, the management store can request, to the CIT company 160, collection of cash from the cash handling apparatus 100 and/or replenishment of cash to the cash handling apparatus 100. The notification on the request is transmitted via the communication unit 90 to the communication terminal 165 used by the CIT company 160, and the CIT company 160 performs the collection and/or the replenishment of cash based on the request.

The cash handling unit 10 performs a plurality of kinds of cash handling including the depositing process and the dispensing process. The cash handling unit 10 includes an inlet 11, an outlet 12, a recognition unit 20, a storage unit 31, a collection unit 32, and a transport unit 40.

The inlet 11 can receive cash from outside the apparatus and feed the cash to a transport path, by which the transport unit 40 transports cash, inside the cash handling apparatus 100. The transport unit 40 can transport the cash along the transport path between the inlet 11, the outlet 12, the recognition unit 20, the storage unit 31, and the collection unit 32. For example, the transport unit 40 is configured to include at least one of a roller and a belt.

The recognition unit 20 can recognize cash being transported by the transport unit 40. For example, the denomination and authenticity of cash are recognized. The recognition unit 20 may recognize the fitness, i.e., the degree of damage based on a predetermined criterion, of cash. The recognition unit 20 may be composed of a plurality of sensors. The sensors may include at least one of an image sensor and a magnetic sensor.

The storage unit 31 can store cash transported by the transport unit 40. The storage unit 31 can feed out, to the transport path, cash to be discharged to outside the apparatus. The number of the storage units 31 is not particularly limited. The kind of cash to be stored in each storage unit 31 can be set. For example, cash can be stored for each denomination by assigning denominations to the respective storage units 31.

The collection unit 32 can store cash transported by the transport unit 40. The collection unit 32 does not perform feeding of cash. The number of the collection units 32 is not particularly limited. The collection unit 32 can be mounted/dismounted with respect to the cash handling unit 10. The collection unit 32 is used for storing cash to be collected to outside the cash handling apparatus 100. Proceeds from sales of the management store and proceeds from sales of other stores are stored in the collection unit 32. The CIT company can dismount the collection unit 32 from the cash handling apparatus 100, and collect the entirety of the proceeds from sales in the apparatus. The cash handling apparatus 100 can be replenished with cash from the collection unit 32. The CIT company mounts the collection unit 32, which stores cash used for replenishment, to the cash handling apparatus 100. The cash is fed out from the collection unit 32, recognized by the recognition unit 20 and stored in the storage unit 31.

The outlet 12 can discharge cash transported by the transport unit 40 to outside the cash handling apparatus 100. For example, cash fed out from the storage unit 31 is discharged from the outlet 12. For example, out of the cash received in the inlet 11 and fed out to the transport path in the apparatus, cash of a kind that cannot be stored in the storage unit 31 may be discharged from the outlet 12.

In the depositing process, cash received in the inlet 11 is transported by the transport unit 40 and recognized by the recognition unit 20, and then stored into the storage unit 31. In the dispensing process, cash is fed out from the storage unit 31, transported by the transport unit 40, recognized by the recognition unit 20, and then, discharged from the outlet 12 to outside the apparatus. In the dispensing process, cash fed out from the storage unit 31 may be discharged from the outlet 12 to outside the apparatus, without being recognized by the recognition unit 20. The cash handling unit 10 may perform another cash handling such as a replenishment process for replenishing the storage unit 31 with cash, a collection process for collecting cash from the storage unit 31 to outside the apparatus, a money exchange process for dispensing cash equivalent to deposited cash in a denomination different from that of the deposited cash, and the like.

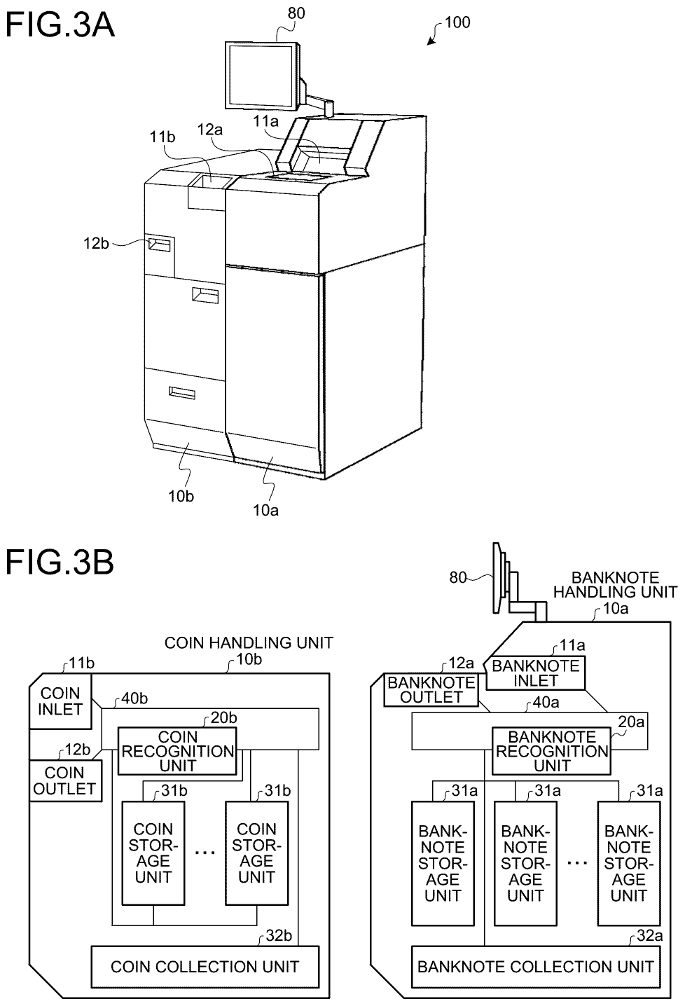

FIGS. 3A and 3B show a specific example of the cash handling apparatus 100. FIG. 3A shows an external view of the cash handling apparatus 100. FIG. 3B is a schematic cross-sectional view showing the internal configuration of the cash handling apparatus 100. In the example shown in FIGS. 3A and 3B, the operation/display unit 80 is provided at the upper face of the cash handling apparatus 100. In the cash handling apparatus 100 shown in FIGS. 3A and 3B, the cash handling unit 10 shown in FIG. 2 is divided into a banknote handling unit 10a for handling banknotes and a coin handling unit 10b for handling coins.

A banknote depositing process is performed such that banknotes received in a banknote inlet 11a are transported by a banknote transport unit 40a, recognized by a banknote recognition unit 20a, and stored into a banknote storage unit 31a or a banknote collection unit 32a. A coin depositing process is performed such that coins received in a coin inlet 11b are transported by a coin transport unit 40b, recognized by a coin recognition unit 20b, and stored into a coin storage unit 31b or a coin collection unit 32b.

A banknote dispensing process is performed such that banknotes fed out from the banknote storage unit 31a are transported by the banknote transport unit 40a, recognized by the banknote recognition unit 20a, and discharged from a banknote outlet 12a. A coin dispensing process is performed such that coins fed out from the coin storage unit 31b are transported by the coin transport unit 40b, recognized by the coin recognition unit 20b, and discharged from a coin outlet 12b.

During the banknote dispensing process, banknotes may not necessarily be recognized by the banknote recognition unit 20a. For example, when banknotes are stored in the banknote storage unit 31a for each denomination, the dispensing process may be performed by counting the number of banknotes fed out from each banknote storage unit 31a by using a sensor or the like to specify a dispensed number of banknotes for each denomination. For example, when the banknote storage unit 31a is a tape-type storage unit that stores, by sequentially winding, banknotes one by one around a drum by using one or a plurality of tapes, and feeds out banknotes in an order opposite to that at the time of storing of banknotes, the denominations of stored banknotes are stored in the memory 70 and the dispensing process may be performed by specifying the denomination of each banknote fed out during the dispensing process. Similarly, during the coin dispensing process, the coin recognition unit 20b may not necessarily recognize coins. For example, when coins are stored in the coin storage unit 31b for each denomination, the dispensing process may be performed such that the number of coins fed out from each coin storage unit 31b is counted by using a sensor or the like, and a dispensed number of coins for each denomination is specified.

Each banknote storage unit 31a and each coin storage unit 31b shown in FIG. 3B correspond to the storage unit 31 shown in FIG. 2, and the banknote collection unit 32a and the coin collection unit 32b shown in FIG. 3B correspond to the collection unit 32 shown in FIG. 2. Hereinafter, “storage unit 31” refers to at least one of the banknote storage unit 31a and the coin storage unit 31b, “collection unit 32” refers to at least one of the banknote collection unit 32a and the coin collection unit 32b, and “cash” refers to at least one of banknotes and coins.

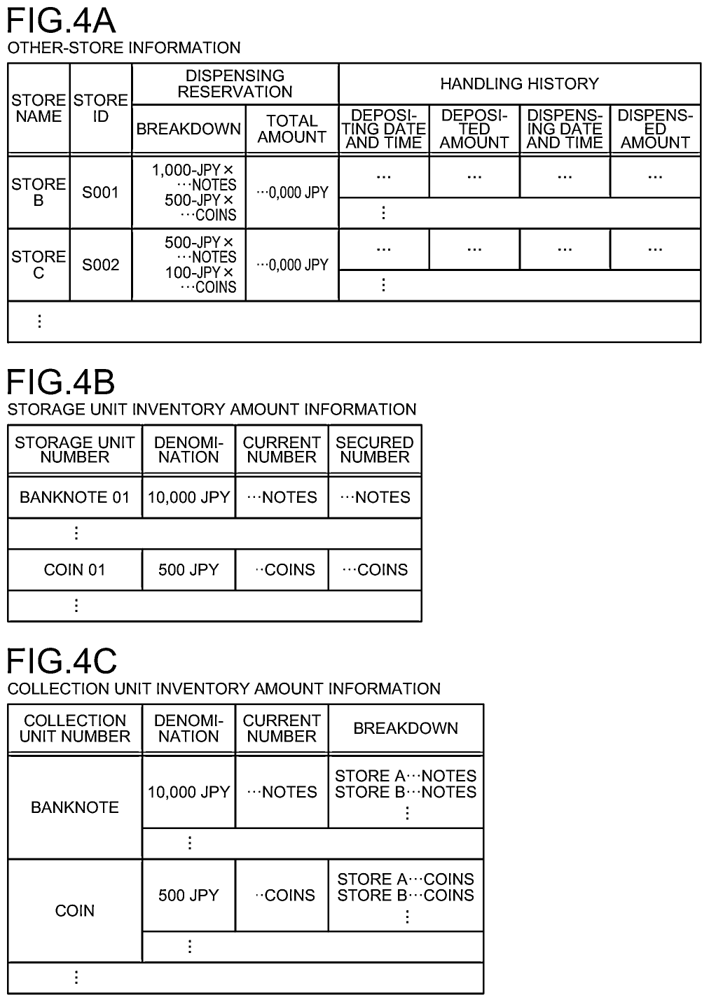

FIGS. 4A to 4C each show an example of information used by the cash handling apparatus 100. FIG. 4A shows an example of the other-store information including information on other stores. FIG. 4B shows an example of storage unit inventory amount information including information on cash being stored in the storage unit 31. FIG. 4C shows an example of collection unit inventory amount information including information on cash being stored in the collection unit 32. As described with reference to FIG. 2, each of these pieces of information may be stored in the memory 70 of the cash handling apparatus 100, or the server 150 communicably connected to the cash handling apparatus 100.

As shown in FIG. 4A, the other-store information includes “store name”, “store ID”, “dispensing reservation”, and “handling history”. The store name and the store ID are the name and the store ID of each of other stores that are allowed to use the cash handling apparatus 100.

The dispensing reservation includes “breakdown” and “total amount”. The breakdown includes denominations and the quantity for each denomination of the change fund reserved in a dispensing reservation made by each of other stores. The total amount indicates the amount of the change fund reserved by the dispensing reservation, i.e., the amount obtained by totaling the amounts of cash designated for each denomination in the breakdown. With respect to other stores not having made a dispensing reservation, the dispensing reservation becomes blank.

The handling history includes “depositing date and time”, “deposited amount”, “dispensing date and time”, and “dispensed amount”. The depositing date and time is the date and time when each of other stores performed a depositing process, and the deposited amount is the amount of cash deposited in the depositing process. The dispensing date and time is the date and time when each of other stores performed a dispensing process, and the dispensed amount is the amount of cash dispensed in the dispensing process.

The other-store information is an example and may not include a part of the information in FIG. 4A, or may include information that is not in FIG. 4A. For example, the other-store information may not necessarily include the handling history. The other-store information may include information such as a password to be used in the authentication process or an account number to be used in account handling. The other-store information may include the amount of proceeds from sales that has been deposited into the bank account of the other store and/or the account handling date and time.

As shown in FIG. 4B, the storage unit inventory amount information includes “denomination” and “current number” for each denomination of banknotes stored in each of the banknote storage units 31a, and “denomination” and “current number” for each denomination of coins stored in each of the coin storage units 31b. Each storage unit 31a, 31b is distinguished by a storage unit number.

For example, when banknote denominations are respectively assigned to the banknote storage units 31a and banknotes are stored for each denomination therein, the banknote denomination assigned to each banknote storage unit 31a and the current number of banknotes stored in the banknote storage unit 31a are managed by the storage unit inventory amount information as shown in FIG. 4B. Similarly, when coin denominations are respectively assigned to the coin storage units 31b and coins are stored for each denomination therein, the coin denomination assigned to each coin storage unit 31b and the current number of coins stored in the coin storage unit 31b are managed by the storage unit inventory amount information as shown in FIG. 4B.

The secured number shown in FIG. 4B is the quantity of cash set, by the management store, to be secured in the cash handling apparatus 100. The management store can set the secured number for each denomination of banknotes and coins. The management store can secure banknotes and coins necessary in business hours of its own store, in the cash handling apparatus 100 by setting the secured number for each denomination.

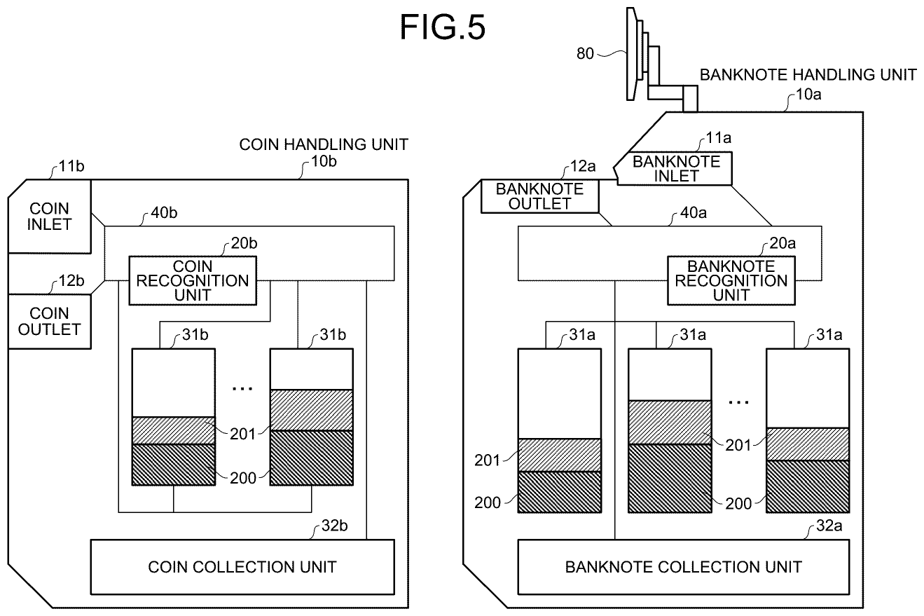

The cash handling apparatus 100 restricts dispensing of banknotes and coins by other stores, to a range in which the number of banknotes and coins for each denomination does not become less than the secured number set for each denomination. For example, as shown in FIG. 5, the cash stored in each storage unit 31 (31a, 31b) includes cash 200 corresponding to the secured number and cash 201 other than that. The cash 201 may include cash prepared by the management store based on dispensing reservations from other stores and cash prepared by the management store so as to be ready for unreserved dispensing processes.

The cash handling apparatus 100 performs the dispensing process for other stores within the range of the quantity of the cash 201. Dispensing of banknotes by other stores is performed within the range of the number of banknotes 201 excluding banknotes 200 secured in each banknote storage unit 31a. Dispensing of coins by other stores is performed within the range of the number of coins 201 excluding coins 200 secured in each coin storage unit 31b.

As shown in FIG. 4C, the collection unit inventory amount information includes “denomination”, “current number” for each denomination, and “breakdown” of banknotes stored in the banknote collection unit 32a, and “denomination”, “current number” for each denomination, and “breakdown” of coins stored in the coin collection unit 32b. In the breakdown, the amount of cash collected from the management store and the amount of cash collected from each of other stores can be specified.

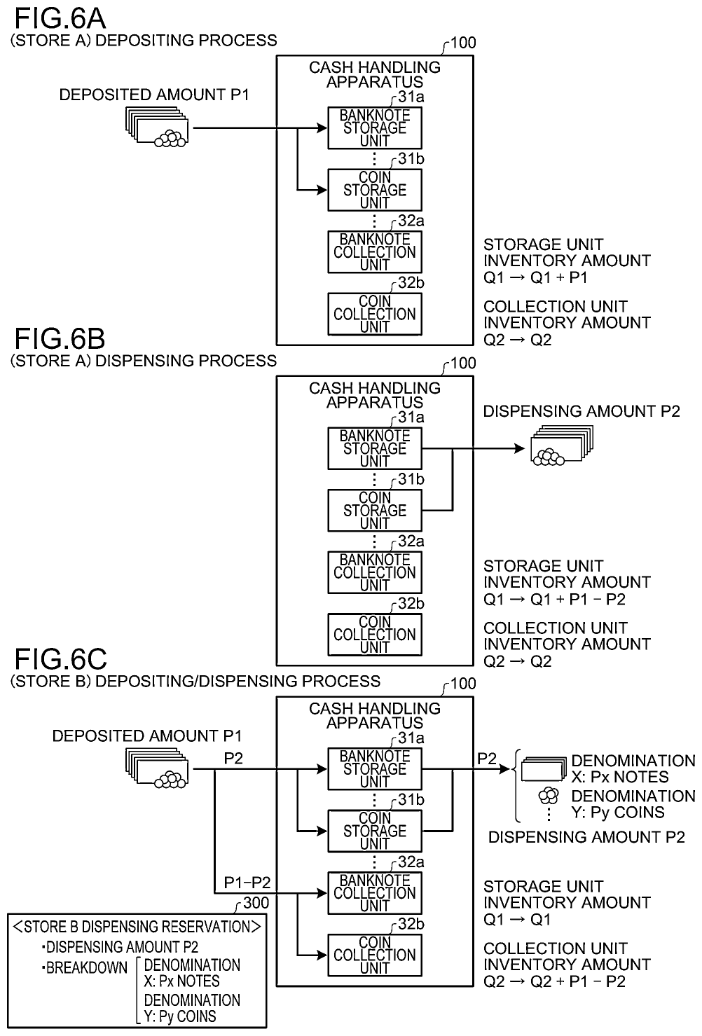

FIGS. 6A to 6C each show a schematic diagram for describing an example of cash handling performed by the cash handling apparatus 100. As shown in FIGS. 6A to 6C, the cash handling apparatus 100 can handle cash differently for the cash handling performed by the management store (store A), and the cash handling performed by the other store (store B).

When the store A has performed a depositing process to deposit cash equivalent to a deposited amount P1, the cash handling apparatus 100 recognizes the denominations of the banknotes and the coins, stores the banknotes into the banknote storage unit 31a, and stores the coins into the coin storage unit 31b, as shown in FIG. 6A. Having finished the depositing process, the cash handling apparatus 100 updates the storage unit inventory amount information shown in FIG. 4B.

When the total amount of cash stored in each storage unit 31 before the depositing process is an amount Q1, the total amount after the depositing process becomes an amount (Q1+P1) as shown in FIG. 6A. When the total amount of cash stored in each collection unit 32 before the depositing process is an amount Q2, the total amount after the depositing process remains at the amount Q2 as shown in FIG. 6A.

After the depositing process shown in FIG. 6A, when the store A has successively performed a dispensing process to dispense cash equivalent to a dispensing amount P2, the cash handling apparatus 100 feeds out banknotes from the banknote storage unit 31a to dispense the banknotes, and feeds out coins from the coin storage unit 31b to dispense the coins as shown in FIG. 6B. Having finished the dispensing process, the cash handling apparatus 100 updates the storage unit inventory amount information shown in FIG. 4B.

After the depositing process shown in FIG. 6A, the total amount of cash in the storage unit 31, which has become the amount (Q1+P1), becomes an amount (Q1+P1−P2) as shown in FIG. 6B. The total amount of cash stored in each collection unit 32 is unchanged, and remains at the amount Q2 as shown in FIG. 6B.

It is assumed that the store B performs a depositing process for depositing cash equivalent to the deposited amount P1, and a dispensing process for dispensing cash equivalent to the dispensing amount P2 reserved in a dispensing reservation 300 shown in FIG. 6C. In this case, similar to the handling shown in FIG. 6A and FIG. 6B, the depositing process for the deposited amount P1 is performed and then the dispensing process for the dispensing amount P2 is performed, but the contents of the handling are different from those in FIG. 6A and FIG. 6B.

Specifically, as shown in FIG. 6C, the cash handling apparatus 100 stores, into the storage unit 31, only cash equivalent to the dispensing amount P2 reserved in the dispensing reservation, out of cash equivalent to the deposited amount P1 deposited by the store B. The cash handling apparatus 100 stores, into the collection unit 32, cash equivalent to an amount (P1−P2) obtained by subtracting the dispensing amount P2 from the deposited amount P1. For example, after starting the depositing process, until the total amount of cash having been stored in the storage unit 31 reaches the amount P2, the cash handling apparatus 100 stores the deposited cash into the storage unit 31, and thereafter, stores the deposited cash into the collection unit 32. Having finished the depositing process, the cash handling apparatus 100 updates the storage unit inventory amount information and the collection unit inventory amount information.

Having finished the depositing process by the store B, the cash handling apparatus 100 starts a dispensing process for the store B based on the dispensing reservation 300, and dispenses cash equivalent to the dispensing amount P2 from the storage unit 31. The cash handling apparatus 100 dispenses cash in the denominations and the quantity for each denomination designated by the store B in the dispensing reservation 300. In the example shown in FIG. 6C, cash equivalent to the amount P2 including Px banknotes in denomination X dispensed from the banknote storage unit 31a and Py coins in denomination Y dispensed from the coin storage unit 31b is dispensed. Having finished the dispensing process, the cash handling apparatus 100 updates the storage unit inventory amount information.

When the total amount of cash stored in each storage unit 31 before the cash handling by the store B was the amount Q1 that is the same as that in FIG. 6A, the total amount after the cash handling remains at the amount Q1 as shown in FIG. 6C. Meanwhile, when the total amount of cash stored in each collection unit 32 before the cash handling was the amount Q2 as in FIG. 6B, the total amount after the cash handling becomes an amount (Q2+P1−P2) as shown in FIG. 6C.

When the other store deposits cash including proceeds from sales and dispenses a change fund, the cash handling apparatus 100 stores cash equivalent to the amount of the change fund into the storage unit 31, and dispenses the change fund in the denominations and the quantity for each denomination designated by the other store, from the storage unit 31. Therefore, the total amount of cash stored in the storage unit 31 remains unchanged before and after the other store performs the depositing process and the dispensing process.

The proceeds from sales deposited by the other store is stored into the collection unit 32. The account handling is performed as described above, and the amount (P1−P2) of cash collected in the collection unit 32 shown in FIG. 6C is deposited into the bank account of the other store as the proceeds from sales. The proceeds from sales are collected from the cash handling apparatus 100 by the CIT company, and transported to a bank or a cash center to be handled.

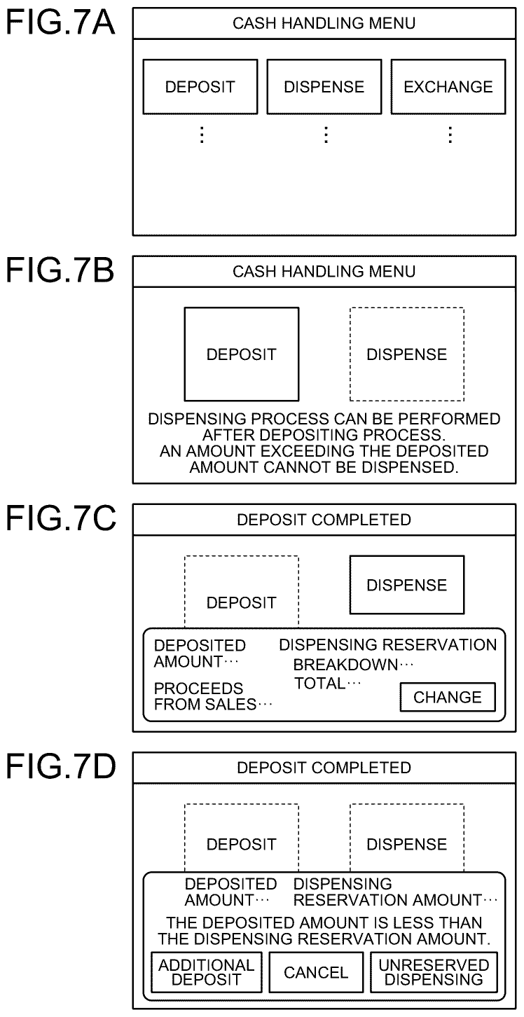

FIGS. 7A to 7D each show an example of a screen to be displayed on the operation/display unit 80 when the cash handling apparatus 100 performs cash handling. The cash handling apparatus 100 performs an authentication process to determine whether the store that performs cash handling is the management store or the other store. When the authenticated store is the management store, the cash handling apparatus 100 displays a management store menu screen shown in FIG. 7A. When the authenticated store is the other store, the cash handling apparatus 100 displays an other-store menu screen shown in FIG. 7B.

As shown in FIG. 7A, the management store menu screen shows buttons corresponding to the kinds of cash handling that can be performed by the management store. The kinds of cash handling include “deposit” for a depositing process, “dispense” for a dispensing process, and “exchange” for a money exchange process. As shown in FIG. 7B, the other-store menu screen shows buttons corresponding to the kinds of cash handling that can be performed by the other store. In the example shown in FIG. 7B, the kinds of cash handling that can be performed by the other store is restricted to “deposit” for a depositing process and “dispense” for a dispensing process, and a button for a money exchange process is not included in the other-store menu.

As shown in FIG. 7B, information on the restriction that the management store has set for the other store is displayed on the other-store menu screen. For example, information indicating that the other store cannot perform a dispensing process until after performing a depositing process is displayed. For example, information indicating that the other store cannot dispense cash equivalent to an amount exceeding the deposited amount is displayed.

In the example shown in FIG. 7B, the deposit button for starting a depositing process is displayed so as to be operable, whereas the dispense button for starting a dispensing process is grayed out and is not operable. In FIGS. 7A to 7D, the button grayed out and not operable is indicated by a broken line.

When the other store has pressed the deposit button on the menu screen in FIG. 7B, the cash handling apparatus 100 starts a depositing process for cash that the other store deposits. Having finished the depositing process, the cash handling apparatus 100 displays a screen shown in FIG. 7C. The screen shows the deposited amount obtained by performing the depositing process, the amount of the proceeds from sales that may be a part of the deposited amount, and the content of the dispensing reservation that has been reserved by the other store. The dispense button having been grayed out on the screen in FIG. 7B is displayed so as to be operable on the screen in FIG. 7C that is shown after the depositing process.

When the other store having confirmed the screen in FIG. 7C presses the dispense button, the cash handling apparatus 100 starts a dispensing process and dispenses the change fund in the denominations and the quantity for each denomination designated in the dispensing reservation. The amount obtained by subtracting the dispensing amount from the deposited amount is deposited as the proceeds from sales into the bank account of the other store.

The dispense button may not necessarily be displayed on the menu screen in a state of being grayed out and then displayed so as to be operable after the depositing process. The dispense button may not be displayed on the menu screen and may be displayed for the first time on the screen after the depositing process is finished.

After the depositing process is finished, a change button is displayed on the screen as shown in FIG. 7C. The other store can change, by operating the change button, the denominations and the quantity for each denomination of cash to be dispensed, from those designated in the dispensing reservation.

Even when the other store changes at least one of the denominations and the quantity for each denomination from those in the dispensing reservation in order to perform an unreserved dispensing process, the dispensable cash is also restricted to an amount equal to or less than the deposited amount. When the management store has set the secured number of cash to keep the secured cash inside the apparatus, the cash that the other store can dispense is restricted to the cash excluding the secured cash. When the management store has prepared cash for unreserved dispensing processes, the cash that the other store can dispense in the unreserved dispensing process may be restricted to the prepared cash.

When the other store has changed the amount and/or the breakdown of cash to be dispensed within the restricted range, and then has pressed the dispense button on the screen in FIG. 7C, the cash handling apparatus 100 performs a dispensing process according to the changed amount and/or the changed breakdown.

For example, when cash for change has run short during business hours and it becomes necessary to dispense cash for change from the cash handling apparatus 100, the other store can perform an unreserved dispensing process after pressing the deposit button on the menu screen in FIG. 7B. After starting the depositing process, the other store deposits cash in an amount equal to or more than the total amount of cash that the other store wants to dispense for change. The cash handling apparatus 100 performs the depositing process and then displays a screen shown in FIG. 7D.

The screen in FIG. 7D is displayed when the deposited amount is less than the dispensing amount of the change fund designated in the dispensing reservation. On the screen, the deposited amount obtained by performing the depositing process and information indicating that the deposited amount is less than the dispensing amount in the dispensing reservation are displayed. Buttons for “additional deposit”, “cancel”, “unreserved dispensing” are also displayed on the screen.

The other store can additionally deposit cash by pressing the additional deposit button. After the additional cash has been deposited, if the deposited amount has become equal to or more than the amount designated in the dispensing reservation, the screen in FIG. 7C is displayed, and if the deposited amount is less than the amount designated in the dispensing reservation, the screen in FIG. 7D is displayed again.

The other store can cancel the depositing process by pressing the cancel button shown in FIG. 7D. The cash handling apparatus 100 stores deposited cash into the storage unit 31 until the amount of deposited cash reaches the amount designated in the dispensing reservation. When the cancel button has been pressed, the cash handling apparatus 100 feeds out cash from the storage unit 31 and returns the cash from the outlet 12. Therefore, when the other store has canceled the cash handling, the quantity of cash stored in each storage unit 31 returns to the quantity before the depositing process was started.

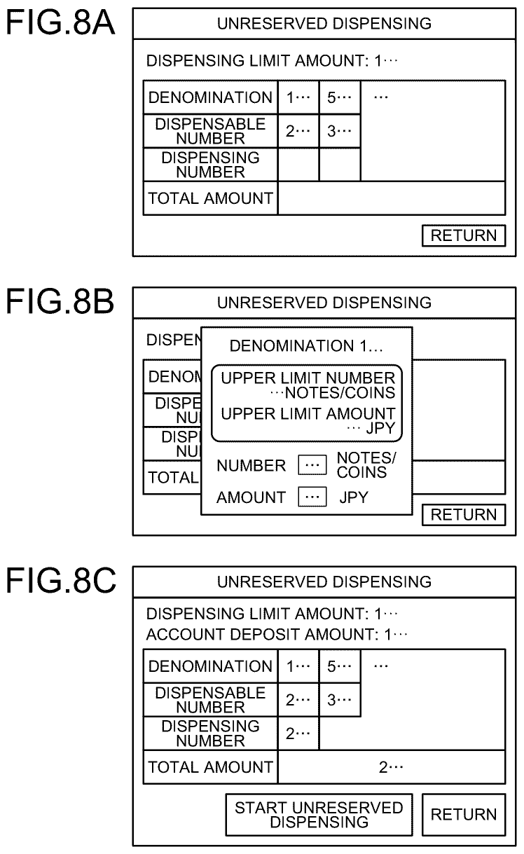

The other store can dispense cash in an amount and breakdown different from those in the dispensing reservation, by pressing the unreserved dispensing button on the screen in FIG. 7D. When the other store has pressed the unreserved dispensing button on the screen in FIG. 7D, a screen shown in FIG. 8A is displayed. When the other store has pressed a return button on the screen in FIG. 8A, the screen returns to the screen in FIG. 7D.

On the screen in FIG. 8A, the upper limit amount of cash that can be dispensed by the other store is displayed as the dispensing limit amount. For example, the deposited amount, which has been obtained by performing the depositing process of cash of the other store, is displayed as the dispensing limit amount. On the screen, “denomination” and “dispensable number” (quantity) for each denomination of cash that can be dispensed by the other store are displayed. When the management store has set a secured number for each denomination and/or when there is cash for unreserved dispensing prepared by the management store, the cash handling apparatus 100 specifies and displays denominations and the quantity for each denomination of cash that can be dispensed by the other store. When the total amount of cash that can be dispensed by the other store is smaller than the deposited amount by the other store, this total amount of the dispensable cash is displayed, as the dispensing limit amount, instead of the deposited amount.

On the screen in FIG. 8A, the other store can designate denominations and the quantity for each denomination of cash that the other store wants to dispense from the cash handling apparatus 100. When the other store has performed an operation of pressing the display of a denomination or a dispensing number on the screen, a window shown in FIG. 8B is displayed on the operation/display unit 80. The denomination, and the upper limit number and the upper limit amount for the denomination that can be dispensed by the other store are displayed in the window. In the window, the other store can input a number equal to or less than the upper limit number or an amount equal to or less than the upper limit amount. When the other store has inputted a number or an amount, a screen including an unreserved dispensing start button is displayed as shown in FIG. 8C. The display of the total amount on the screen in FIG. 8C is updated based on the input performed by the other store in the window in FIG. 8B. On the screen in FIG. 8C, the amount obtained by subtracting the dispensing amount from the deposited amount is displayed as an account deposit amount. When the other store has pressed a button for starting the unreserved dispensing, the cash handling apparatus 100 starts an unreserved dispensing process and dispenses cash in the denominations and the quantity for each denomination designated by the other store. When the dispensing amount in the unreserved dispensing process is less than the deposited amount, the amount obtained by subtracting the dispensing amount from the deposited amount, i.e., the amount indicated as the account deposit amount on the screen in FIG. 8C, is deposited into the bank account of the other store.

For example, when the store B having made a dispensing reservation equivalent to 100,000 JPY wants to dispense thirty 500-JPY coins for change, if the store B starts a depositing process on the screen in FIG. 7B and deposits 20,000 JPY, the screen in FIG. 7D is displayed and it is notified that the deposited amount is less than 100,000 JPY designated in the dispensing reservation. The store B presses the unreserved dispensing button on the screen in FIG. 7D, and selects “500-JPY coin” on the screen in FIG. 8A. The store B inputs 30 as the number or 15,000 JPY as the amount, in the window displayed for 500-JPY coin shown in FIG. 8B. When the store B has pressed the button for the unreserved dispensing process on the screen in FIG. 8C, the cash handling apparatus 100 performs an unreserved dispensing process of dispensing thirty 500-JPY coins. The cash handling apparatus 100 performs a process for depositing 5,000 JPY obtained by subtracting the dispensing amount of 15,000 JPY from the deposited amount of 20,000 JPY, into the account of the store B. Account handling information necessary for performing the account handling is transmitted from the cash handling apparatus 100 to the bank server 170, and the bank server 170 performs the account handling of depositing 5,000 JPY into the bank account of the store B.

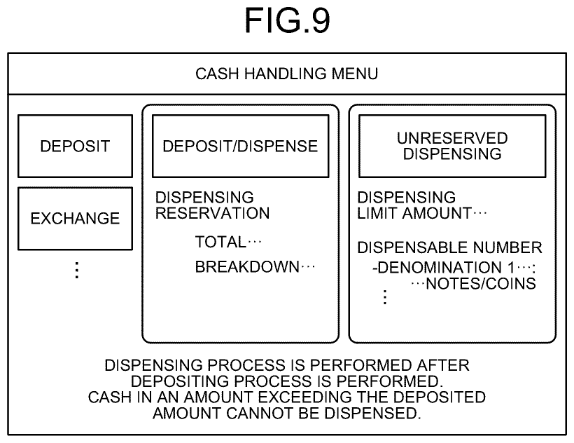

In the examples in FIGS. 7A to 7D, the deposit button and the dispense button are separately displayed on the other-store menu screen as shown in FIG. 7B. However, as shown in FIG. 9, a deposit/dispense button may be displayed on the menu screen for the other store. The breakdown and the amount designated in the dispensing reservation may be displayed on this menu screen. In this case, merely by pressing the deposit/dispense button, the cash handling apparatus 100 starts a depositing process to accept deposit of cash from the other store, and then successively performs a dispensing process based on the dispensing reservation. The management store can select “deposit” for a depositing process or “dispense” for a dispensing process on the management store menu screen shown in FIG. 7A. On the other hand, even on the other-store menu screen shown in FIG. 9, the other store cannot select a button for a dispensing process alone although the other store can select “deposit” or “deposit/dispense”.

In the examples in FIGS. 7A to 7D, when the deposited amount by the other store is less than the amount designated in the dispensing reservation, the unreserved dispense button appears on the screen in FIG. 7D. However, as shown in FIG. 9, the unreserved dispense button may be displayed on the menu screen from the beginning. Information such as the dispensing limit amount, denominations and the quantity for each denomination of cash that can be dispensed by the other store in the unreserved dispensing process may be displayed on this screen. The other store may perform a dispensing process by selecting the unreserved dispensing process, without making a dispensing reservation. When the other store selects the unreserved dispensing process, the cash handling apparatus 100 displays the content of the restriction such as the dispensing limit amount, denominations, and the quantity for each denomination of cash that can be dispensed by the other store, on the screen of the operation/display unit 80. Irrespective of whether or not the other store has made a dispensing reservation, the cash handling apparatus 100 accepts designation of denominations and the quantity of cash to be dispensed by the other store within the range of the restriction displayed on the operation/display unit 80, to perform the unreserved dispensing process.

In the examples in FIGS. 7A to 7D, the other store can perform only cash handling in which the dispensing process is performed after the depositing process. However, the other store may be able to perform a depositing process not followed by a dispensing process. The other store may be able to perform the money exchange process. For example, a deposit button and a money exchange button may be displayed on the menu screen as shown in FIG. 9, and the cash handling apparatus 100 may perform the depositing process or the money exchange process, according to an operation performed by the other store on the menu screen. The kind of cash handling that the other store can perform may be selected and set by the management store.

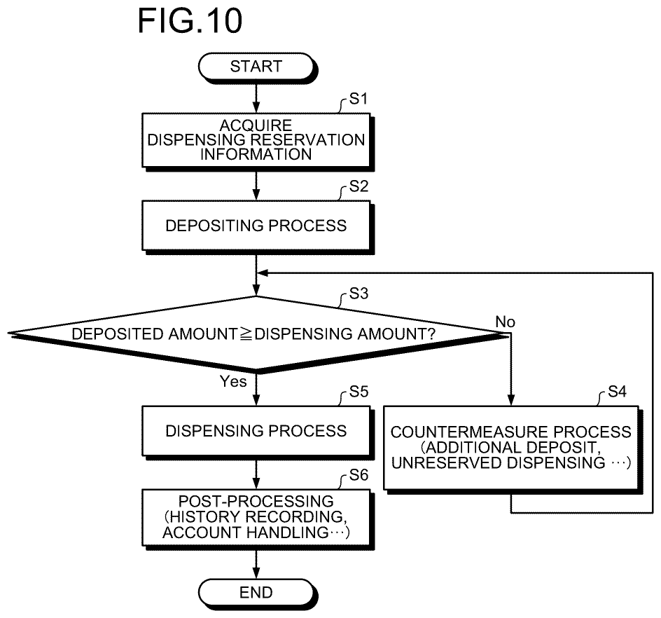

FIG. 10 is a flowchart showing an example of a flow of processing performed by the cash handling apparatus 100. When the other store performs a depositing process for cash including proceeds from sales and a dispensing process for a change fund by using the cash handling apparatus 100, the processing shown in FIG. 10 is started.

Based on the store ID of the other store acquired in the authentication process, the cash handling apparatus 100 refers to the other-store information shown in FIG. 4A, and acquires information on a dispensing reservation made by the other store (step S1). The cash handling apparatus 100 performs a depositing process (step S2). Having finished the depositing process, the cash handling apparatus 100 determines whether or not the deposited amount by the other store is an amount equal to or more than the dispensing amount of cash according to the dispensing reservation (step S3).

When the deposited amount is less than the dispensing amount (step S3; No), the cash handling apparatus 100 performs a process for taking measures against this fact (step S4). For example, an additional depositing process of depositing additional cash is performed such that the total deposited amount exceeds the dispensing amount in the dispensing reservation. For example, in order to perform unreserved dispensing, a process of changing the dispensing amount to an amount equal to or less than the deposited amount is performed.

When the deposited amount is equal to or more than the dispensing amount (step S3; Yes), the cash handling apparatus 100 performs a dispensing process (step S5). When the process in step S4 has not been performed, or the additional deposit is performed in step S4 and the deposited amount has become equal to or more than the dispensing amount in the dispensing reservation, the cash handling apparatus 100 dispenses cash in the denominations and the quantity for each denomination designated in the dispensing reservation by the other store. When the other store has changed in step S4, the amount and the breakdown of cash to be dispensed, the cash handling apparatus 100 dispenses cash equivalent to the changed amount and breakdown.

The cash handling apparatus 100 performs post-processing (step S6), and ends the processing. The post-processing may include a process of registering information into the handling history of the other-store information. The post-processing includes a process for depositing the amount obtained by subtracting the dispensing amount from the deposited amount into the bank account of the other store.

In the present embodiment, an example in which the cash handling apparatus 100 handles both banknotes and coins has been described. However, the cash handling apparatus 100 may handle only banknotes or may handle only coins.

In the present embodiment, various processes performed by the cash handling apparatus 100 have been described. However, the cash handling apparatus 100 may not necessarily perform all these processes, and may perform a part of these processes. With respect to the examples of screens that the cash handling apparatus 100 displays, all pieces of exemplified information may not necessarily be displayed, and a part of the information may be displayed on the screen.

In the present embodiment, an example in which the cash handling apparatus 100 performs cash handling has been described. However, a part of components of the cash handling apparatus 100 may be independently provided to form the cash handling system 1, and the cash handling system 1 may perform the cash handling.

In the present embodiment, an example in which cash is deposited through the inlet 11 and cash is dispensed through the outlet 12 has been described. However, the depositing process and the dispensing process may be performed using a cash cassette that can be mounted to and dismounted from both the cash handling apparatus 100 of the management store and another cash handling apparatus of the other store. Movement of cash between the two apparatuses using the cash cassette may be performed in a conventionally known manner. If cash is moved using the cash cassette between the cash handling apparatus 100 and the cash handling apparatus for the other store, security for cash transport can be secured.

In the present embodiment, an example, in which cash equivalent to the dispensing amount reserved by the dispensing reservation out of the deposited cash is stored into the storage unit 31 during the depositing process by the other store (store B), has been described. However, the cash storing method is not limited thereto. For example, the cash handling apparatus 100 may store all the cash deposited by the other store, into the collection unit 32 or the storage unit 31.

In the present embodiment, an example, in which the storage place for the deposited cash is changed between the depositing process by the management store (store A) and the depositing process by the other store (store B), has been described. However, the cash storage method is not limited thereto. During the depositing process by the management store, the cash handling apparatus 100 may store at least a part of the deposited cash into the collection unit 32. For example, the cash handling apparatus 100 may store large-denomination banknotes not to be used as change, into the banknote collection unit 32a. The cash handling apparatus 100 may perform a determination process based on the available capacity of the storage unit 31, and when the available capacity of the storage unit 31 is small, the cash handling apparatus 100 may store the deposited cash into the collection unit 32. During the depositing process by the other store, the cash handling apparatus 100 may store proceeds from sales of the other store into the storage unit 31, to be recycled in the dispensing process.

A cash handling apparatus according to the present disclosure is a cash handling apparatus with which a predetermined store and another store different from the predetermined store perform cash handling. The cash handling apparatus includes: a cash handling unit configured to handle cash; and a control unit configured to control the cash handling unit to perform cash handling including a depositing process of storing, into the apparatus, cash received from outside the apparatus, and a dispensing process of discharging cash stored in the apparatus to outside the apparatus. The control unit determines whether a store that performs the cash handling is the predetermined store or the other store. In a case where the store is the other store, the control unit restricts the dispensing process, based on a predetermined dispensing restriction.

In the above configuration, the control unit may accept a dispensing restriction set for the other store by the predetermined store, and may restrict the dispensing process, based on the dispensing restriction.

In the above configuration, the control unit may restrict a period in which the other store is allowed to perform the dispensing process.

In the above configuration, the control unit may restrict the dispensing process by the other store such that the dispensing process can be performed only after the depositing process has been performed by the other store.

In the above configuration, the control unit may restrict a dispensing amount of cash that can be dispensed by the other store in the dispensing process, to a range in which the dispensing amount does not exceed a deposited amount of cash in the depositing process that has been performed by the other store.

In the above configuration, the control unit may restrict the dispensing process that can be performed by the other store, to a dispensing process based on a dispensing reservation reserved by the other store, in which denominations and a quantity for each denomination of cash to be dispensed for the other store are designated by the other store.

In the above configuration, the control unit may accept change and deletion of the dispensing reservation of the other store by the predetermined store. In the above configuration, in a case where the dispensing reservation is present, the control unit may restrict the dispensing process by a store that has not made a dispensing reservation.

In the above configuration, the control unit may perform a process for a cash replenishment request, based on the denominations and the quantity for each denomination of cash reserved in the dispensing reservation.

In the above configuration, the dispensing restriction may be set for each of a plurality of other stores, and the control unit may identify each of the other stores, and may restrict the dispensing process, based on the dispensing restriction corresponding to the other store that performs cash handling.

In the above configuration, the cash handling apparatus may further include a memory configured to store identification information for identifying each of the plurality of other stores and the dispensing restriction set for a corresponding one of the other stores so as to be associated with each other. The control unit may identify the other store, based on the identification information, and may restrict the dispensing process, based on the dispensing restriction associated with the identification information.

In the above configuration, the cash handling apparatus may further include an acquisition unit configured to acquire, from an external device storing identification information for identifying each of the plurality of other stores and the dispensing restriction set for a corresponding one of the other stores so as to be associated with each other, the identification information and the dispensing restriction. Based on the information acquired from the external device, the control unit may identify the other store, based on the identification information, and may restrict the dispensing process, based on the dispensing restriction associated with the identification information.

In the above configuration, the predetermined store may be a store that manages cash stored in the apparatus.

In the above configuration, the predetermined store may be a store in which the cash handling apparatus is installed. In the above configuration, the predetermined store may be a store that manages cash replenishment to the cash handling apparatus and cash collection from the cash handling apparatus.

In the above configuration, the cash handling unit may include: a recognition unit configured to recognize kinds of cash; a first storage unit configured to perform storing of cash and feeding out of cash stored therein from the first storage unit; and a second storage unit configured not to perform feeding out of cash from the second storage unit and configured to perform only storing of cash in the second storage unit. When performing the depositing process, the control unit may cause the first storage unit and the second storage unit to store cash by kind, based on a result of recognition performed by the recognition unit.

In the above configuration, in a case where a dispensing reservation has been made by the other store, in which denominations and a quantity for each denomination of cash to be dispensed for the other store are designated, the control unit may cause cash in the denominations designated in the dispensing reservation to be stored in the first storage unit, and causes cash in another denomination to be stored in the second storage unit.

According to the cash handling apparatus of the present disclosure, a plurality of stores can use one cash handling apparatus. By restricting the dispensing process performed by using the cash handling apparatus, it is possible to avoid a situation where one of the stores dispenses a large quantity of cash, resulting in shortage of cash in the cash handling apparatus, and another store cannot dispense cash, for example.

The function realized by the configuration described in this specification may be implemented in one or a plurality of electric circuits or processing circuits, programmed so as to realize the function, including one or a plurality of general-purpose processors, application specific processors, integrated circuits, ASICs (Application Specific Integrated Circuits), CPUs (Central Processing Units), conventional-type circuits, and/or a combination of these. The processor may be an electric circuit or a processing circuit including a transistor and another circuit. The kind of the processor is not particularly limited as long as the processor can perform the program stored in a memory.

The configuration described in this specification may be hardware that realizes the described functions and operations, or may be hardware programmed so as to realize the described functions and operations. For example, when the hardware is considered to be an electric circuit or a processing circuit, the hardware may include a processor and a software program for realizing the function and configuration of the hardware. For example, when the hardware includes a physical structure such as parts and driving mechanisms, the hardware may include, in addition to the physical structure, a processor and a software program for realizing the functions and configuration of the hardware by controlling the operations of the physical structure. Each configuration described in this specification is an example of hardware, and each configuration may be realized by using other hardware that can realize the functions and operations described in this specification.

1. A cash handling apparatus with which a predetermined store and another store different from the predetermined store perform cash handling, the cash handling apparatus comprising:
a cash handling unit configured to handle cash; and
a control unit configured to control the cash handling unit to perform cash handling including a depositing process of storing, into the cash handling apparatus, cash received from outside the apparatus, and a dispensing process of discharging cash stored in the cash handling apparatus to outside the cash handling apparatus, wherein
the control unit determines whether a store that performs the cash handling is the predetermined store or the other store, and in a case where the store is the other store, the control unit restricts the dispensing process, based on a predetermined dispensing restriction.

2. The cash handling apparatus according to claim 1, wherein the control unit accepts a dispensing restriction set for the other store by the predetermined store, and restricts the dispensing process, based on the dispensing restriction.

3. The cash handling apparatus according to claim 1 wherein the control unit restricts a period in which the other store is allowed to perform the dispensing process.

4. The cash handling apparatus according to claim 1, wherein the control unit restricts the dispensing process by the other store such that the dispensing process can be performed after the depositing process has been performed by the other store.

5. The cash handling apparatus according to claim 4, wherein the control unit restricts a dispensing amount of cash that can be dispensed by the other store in the dispensing process, to a range in which the dispensing amount does not exceed a deposited amount of cash in the depositing process that has been performed by the other store.

6. The cash handling apparatus according to claim 1, wherein the control unit restricts the dispensing process that can be performed by the other store, to a dispensing process based on a dispensing reservation made by the other store, in which denominations and a quantity for each denomination of cash to be dispensed are designated.

7. The cash handling apparatus according to claim 6, wherein the control unit accepts change and deletion of the dispensing reservation by the predetermined store.

8. The cash handling apparatus according to claim 6, wherein the control unit performs a process for a cash replenishment request, based on the denominations and the quantity for each denomination of cash reserved in the dispensing reservation.

9. The cash handling apparatus according to claim 1, wherein
the dispensing restriction is set for each of a plurality of other stores, and
the control unit identifies each of the other stores, and restricts the dispensing process, based on the dispensing restriction corresponding to the other store that performs cash handling.

10. The cash handling apparatus according to claim 9, further comprising
a memory that stores identification information for identifying each of the plurality of other stores and the dispensing restriction set for a corresponding one of the other stores so as to be associated with each other, wherein
the control unit identifies the other store, based on the identification information, and restricts the dispensing process, based on the dispensing restriction associated with the identification information.

11. The cash handling apparatus according to claim 9, further comprising
an acquisition unit configured to acquire, from an external device storing identification information for identifying each of the plurality of other stores and the dispensing restriction set for a corresponding one of the other stores so as to be associated with each other, the identification information and the dispensing restriction, wherein
the control unit identifies the other store, based on the identification information, and restricts the dispensing process, based on the dispensing restriction associated with the identification information.

12. The cash handling apparatus according to claim 1, wherein the predetermined store is a store that manages cash stored in the apparatus.

13. The cash handling apparatus according to claim 1, wherein the predetermined store is a store in which the cash handling apparatus is installed.

14. The cash handling apparatus according to claim 1, wherein
the cash handling unit includes:
a recognition unit configured to recognize kinds of cash;
a first storage unit configured to store cash and feed out cash stored therein; and
a second storage unit configured to store cash but not to feed out cash stored therein, and
in the depositing process, the control unit stores cash in the first storage unit and the second storage unit for each kind, based on a result of recognition performed by the recognition unit.

15. The cash handling apparatus according to claim 14, wherein
in a case where a dispensing reservation has been made by the other store, in which denominations and a quantity for each denomination of cash to be dispensed are designated,
the control unit stores cash in the denominations designated in the dispensing reservation into the first storage unit and cash in other denominations into the second storage unit.
